(19) United States
(12) Patent Application Publication
(10) Pub. No.: US 2006/0092621 A1
(43) Pub. Date: May 4, 2006

(54) Tailpipe decoration

(76) Inventor: Marcos Yu Sin Lai, Diamond Bar, CA (US)

Correspondence Address: LAW OFFICES OF CLEMENT CHENG, 17220 NEWHOPE STREET #127, FOUNTAIN VALLEY, CA, 92708, US

(21) Appl. No.: 10/976,403

(22) Filed: Oct. 29, 2004

(51) Int. Cl. F21V 33/00

(52) U.S. Cl. 362/96; 362/545; 362/487; 362/192

(57) ABSTRACT

A tailpipe decoration has a hollow tubular housing, an axle mounted within the housing, and a first and second set of turbine blades. Each set of turbine blades has a hub with a number of radially mounted turbine blades. The first and second sets of turbine blades are mounted on the axle. Housing connectors mounted on the housing connect the housing to a tailpipe when the housing connectors are engaged. The tailpipe decoration can also have a plurality of electric generators, each with a coil portion and a magnet portion, the magnet portion mounted on either the first or second hub and the coil portion mounted on the housing or a hub so that electric current is generated with the rotation of a hub for illuminating LEDs or the like within the housing.

### FIELD OF THE INVENTION

The present invention relates generally to automotive ornaments, and, more particularly, to a decorative ornament for an automotive tailpipe.

### DISCUSSION OF RELATED ART

Exhaust pipe mounted decorations have in the past included propellers and decorative signs. One example of a tail pipe mounted propeller is the device shown in U.S. Pat. No. 4,897,068 to Jackson. The propeller is free rotating and spins when the vehicle is in motion.

A second example of a tailpipe mounted propeller decoration is shown in the U.S. Pat. No. 6,719,085 to Lee. The improved device includes a spring that automatically retracts the decoration into the tailpipe when not in use.

Other decorations such as decorative signs or supplemental taillight accessories have also been mounted on the tailpipe for decoration. Some decorative signs have included lighted messages. However, no prior art device teaches a tailpipe ornament that resembles a jet engine. Further, no prior art devices teach a self-illuminating decorative tailpipe ornament. The present invention accomplishes these objectives.

### SUMMARY OF THE INVENTION

The present invention is a tailpipe-mounted turbine decoration. A first set of turbine blades is mounted on a first hub and a second set is mounted on a second hub, each set configured to rotate in opposite directions with respect to each other. The hubs are preferably circular with the blades extending radially therefrom. The first hub is preferably a circular element, preferably of conical or bullet shaped profile. Each hub rotates on a bearing mounted at the center of the hub and fixed to an axis. Because the device is a decoration, the blades may be constructed from a stamped circular metal sheet, or be plastic injection molded. The first set of turbine blades have sufficient space between the blades to allow viewing of the second set of blades through the first set of blades. This simulates the appearance of an aeronautic jet turbine engine. A generally hollow, cylindrical housing is mounted to the tailpipe with set screws or the like and includes an axis that is collinearly aligned with the longitudinal axis of the housing. The hubs are each mounted on the axle, which is in turn mounted to a set of frame struts that are fixed to the inside wall of the housing.

The motion of the turbine blades powers a plurality of electric generators that illuminate LEDs or incandescent light bulbs within the housing, creating a visual effect at night. The LEDs are preferably mounted behind the sets of blades so that the geometric interaction between the first and second set of turbine blades is easily observed when looking into the housing.

The electrical generators can be mounted between the turbine blade hubs so that a permanent magnet portion of the electric generator is mounted on either the first or second hub and the coil portion of the electric generator is mounted on the opposite hub. The magnetic force between the hubs can be tuned by adjusting the distance between the first and second hub. Adjusting the distance between the hubs also adjusts the light generated. Spacers in the form of small washers are used to adjust the distance between the hubs.

To more closely simulate an actual jet engine in appearance, metallic coated blades and a metallic coated hub can be used. The metallic coating provides an appearance more consistent with aeronautic jet engines than flat or even gloss paint. A metallic finish also allows light emitted by illumination elements within the housing to reflect outward as well as provide reflection of ambient illumination such as streetlights or the sun.

The blades and hub may also be partially or fully painted. For example, designs such as a flower may be painted on the blade sets. A sunflower may be painted on the blade sets with petal designs painted on the blades and perhaps seed designs painted on the hub. In this case, turbine blade motion moves the design painted on the blades and hub. Other circular patterns can also be painted onto the blades and hub for decoration.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a front elevational view of the preferred embodiment of the invention.

FIG. 2 is a cross-sectional view of the invention, taken generally along lines 2-2 of FIG. 1, and shown as mounted to a tailpipe.

FIG. 3 is a perspective view of the preferred embodiment of the invention, shown as mounted to a tailpipe.

FIG. 4 is an exploded view of the preferred embodiment of the invention.

FIG. 5 is an exploded view of an alternate embodiment of the invention.

FIG. 6 is a table showing different coil/magnet section configurations of generators of the preferred embodiment.

### DETAILED DESCRIPTION OF THE PREFERRED EMBODIMENT

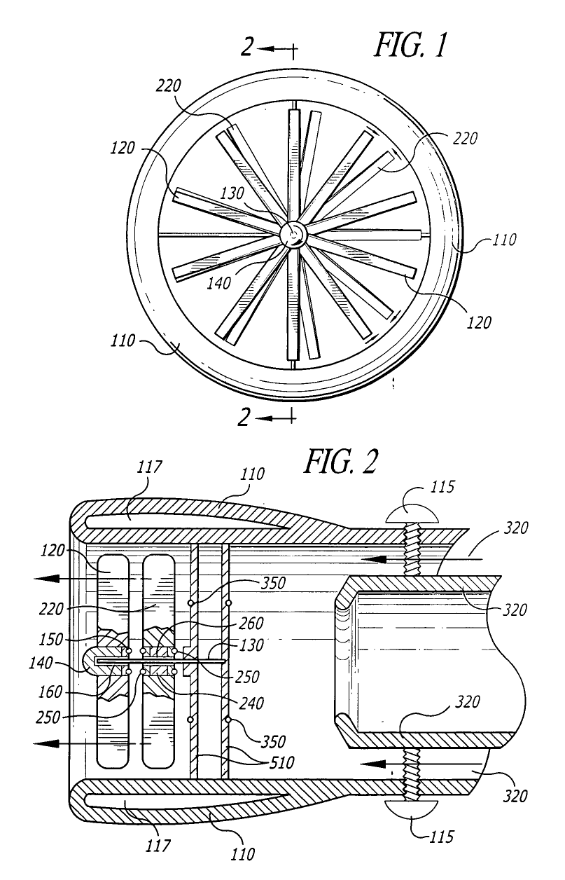

FIGS. 1 and 2 illustrate a tailpipe decoration that resembles a jet engine, and is adapted for mounting on a tailpipe 180 of a vehicle. The device includes a hollow, tubular housing 110 that is fixed to the tailpipe 180 with a plurality of housing connectors, such as screws 115 or the like. The screws 115 are adapted to hold the housing 110 in coaxial alignment with the tailpipe 180. Insofar as the diameter of the housing is preferably greater than the outer diameter of the tailpipe 180, the screws 115 hold the housing 110 away from the tailpipe 180 such that an air gap 320 is maintained between the inner surface of the housing 110 and the outer surface of the tailpipe 180. As such, air is free to flow into the housing 110 from around the tailpipe 180 to create an air current within the housing 110 when in motion. A hollow cowl 117 may further be formed in the housing 110 (FIG. 2) to create in the housing 110 more of the appearance of a jet engine (not shown).

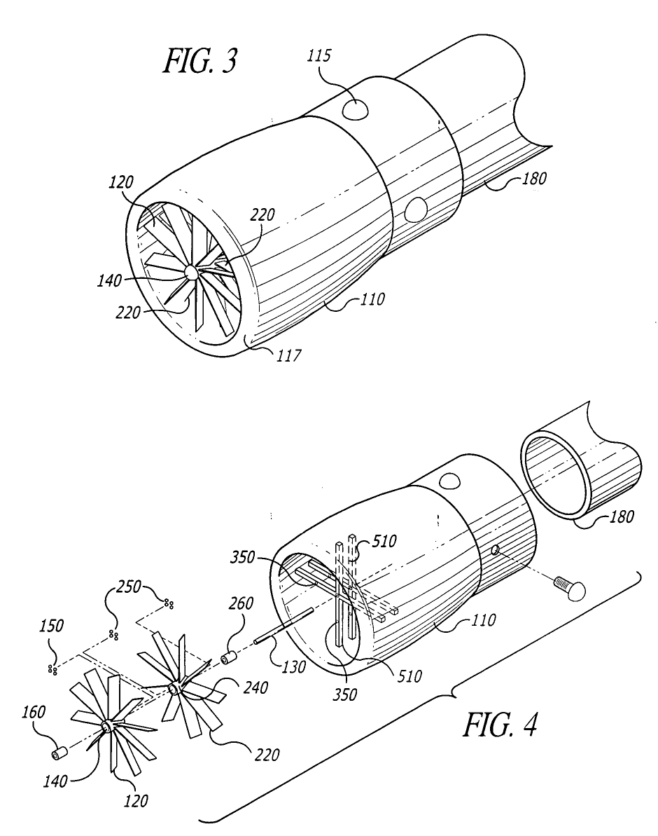

An axle 130 is mounted inside the housing 110 on a plurality of frame struts 510 that traverse the inside the housing 110. The longitudinal axis of the axle 130 is co-aligned with the longitudinal axis of the housing 110 (FIG. 4). The housing 110 is preferably made from a polished metal sheet material, such as aluminum or stainless steel, or a high-temperature rigid plastic material that can be metallically coated or otherwise painted. The frame struts 510 and the axle 130 are made from a rigid metal or metal alloy, and as such can withstand the heat generated of any engine exhaust exiting the tailpipe 180, as well as the dynamic wind forces present when the device is moving through an air stream at relatively high speeds.

A first set 120 and a second set 220 of turbine blades 100 each comprise a hub 140,240 having a number of radially mounted blades 100 mounted thereon (FIGS. 1 and 2). Each hub 140,240 has a bearing 160, 260 to allow free rotation of the blades 100 around the axle 130, such bearings being of any suitable bearing found in the prior art. Preferably the first set 120 of blades 100 is configured to rotate oppositely to the rotational direction configured for the second set 220 of blades 100. This is accomplished by slanting the blades 100 of the first and second set 120, 220 of blades 100 in different directions with respect to each other.

A first and second electric generator 170,270 may be included, each of which includes a coil portion and a magnet portion (FIG. 6). Electrical illumination elements, such as LEDs 150,250,350, may be mounted on either the hubs 140,240 or the frame struts 510, respectively. The illumination elements 150,250,350 are preferably oriented to direct light on the turbine blades 100.

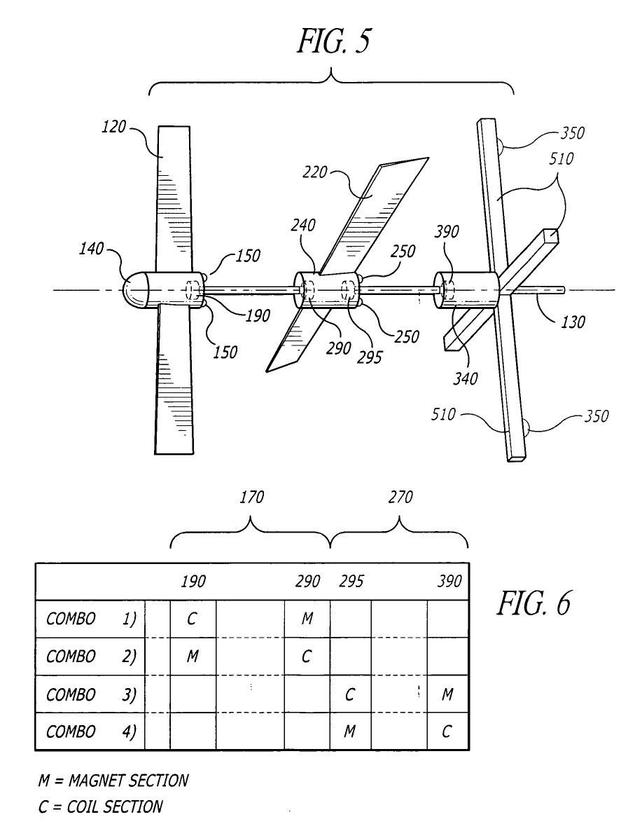

Electrical conductors (not shown) such as wires conduct electricity generated by the first generator 170 to either the LEDs 150,250 on the hubs 140,240, and wires conduct electricity generated by the second generator to the LEDs 250, 350 mounted on the second hub 240 or the frame struts 510, respectively. The sections of each generator 170, 270 are preferably interchangeably mounted in the hub positions 190, 290, 295 and the frame hub position 390 (FIG. 5). The interchangeable modular system for arranging and fixing the coil sections and magnetic sections of each generator 170, 270 allows for various LED placement combinations. The hub positions 190, 290, 295, 390 each include electrical contacts (not shown) that engage corresponding electrical contacts of the coil sections of each generator 170,270 when the coil sections of each generator 170, 270 are properly engaged to the hub positions 190, 290, 295, 390. As such, it is relatively simple to exchange coil and magnet sections of either generator 170, 270 to create a different lighting effect.

For example, in a first combination (FIG. 6) the first generator 170 has its coil section fixed within the rear portion of the first hub 140, such as by snapping into a hollow void formed within the rear facing portion of the first hub 140 and referred to as position 190. The magnet section of the first generator 170 is fixed within a forward-facing portion of the second hub 240 referred to as position 290. When the first and second hubs 140, 240 are in close proximity and spinning in opposite directions the magnet section of the first generator 170 causes electrical current to flow within the coil section of the first generator 170, the coil section being electrically connected to the LEDs 150 for illuminating the first and second sets 120, 220 of the blades. As such, in the first combination, the illumination elements 150 are located in the first hub 140.

Alternately, the first combination can be reversed to form the second combination (FIG. 6) where the coil section is in position 290 and the magnet section is in position 190. In the second combination, the illumination elements 250 are powered by the coil section of the first generator 170 in position 290, and no LEDs 150 are present.

The third combination (FIG. 6) shows the coil portion of the second generator 270 in a position 295 formed in the rear facing portion of the second hub 240, and the magnet portion of the second generator 270 is in a position 390 in a front-facing portion of the frame hub 340. In the third combination, the illumination elements 250 are mounted on the second hub 240. In the fourth combination, the magnet section of the second generator 270 is mounted in the position 295 and the coil portion of the second generator 270 is fixed in position 390. In Such a fourth combination, the illumination elements 350 are mounted on the frame struts 510.

As such, when the first and second sets 120, 220 of blades are rotating in opposite directions about the axis 130, the coil sections and magnet sections of each generator 170, 270 are in close proximity so as to produce electricity in the coil sections, thereby causing a current to flow through the respective LEDs 150, 250, 350, thereby illuminating such LEDs 150, 250, 350 when the rotational speed of the first and second sets 120, 220 of blades 100 reach an electricity generating threshold speed. The coil sections of the first and second generators 170, 270 are interchangeable, thereby providing a variety of possible ornamental effects. Further, LEDs 150, 250, 350 may be tri-color LEDs, such that when current is flowing in a first direction each LED 150, 250, 350 is one particular color, while with current flowing in an opposite direction each LED 150, 250, 350 is of another color. Accordingly, the ornamental effect can be altered by having either combinations 1 and 3, 1 and 4, 2 and 3 or 2 and 4. The ornamental effect can be further increased and personalized by user by adding a third set of blades (not shown) that is identical to the second set 120, but mounted to the axle 130 in the opposite direction so that the blades are oriented oppositely to the blades of the second set 220. Indeed, any number of sets of blades may be added in this manner up to the available length of the axle 130.

While a particular form of the invention has been illustrated and described, it will be apparent that various modifications can be made without departing from the spirit and scope of the invention. For example, the exact number of blades on each hub 140, 240 may be altered, or the style of the blades may be altered from those shown. Accordingly, it is not intended that the invention be limited, except as by the appended claims.

1. A tailpipe decoration comprising:
a. a hollow tubular housing;
b. an axle mounted on the housing;
c. a first and second set of turbine blades, each set of turbine blades comprising a hub having a number of radially mounted blades, wherein the first and second set of turbine blades are mounted on the axle.

2. The tailpipe decoration of claim 1, further comprising: housing connectors mounted on the housing connecting the housing to a tailpipe when the housing connectors are engaged.

3. The tailpipe decoration of claim 1, further comprising: an electric generator comprising a coil portion and a magnet portion, the magnet portion mounted on either the first or second hub and the coil portion mounted on the housing, wherein electric current is generated with the rotation of the hub.

4. The tailpipe decoration of claim 3, further comprising: electrical illumination elements mounted on the housing and powered by the electric current generated with the rotation of the hub.

5. The tailpipe decoration of claim 4, wherein the electrical illumination elements are mounted on the housing behind the second set of turbine blades.

6. The tailpipe decoration of claim 1, wherein the first set of turbine blades has opposite rotational direction from the second set of turbine blades.

7. The tailpipe decoration of claim 6, further comprising: an electric generator comprising a coil portion and a magnet portion, the magnet portion mounted on the first hub and the coil portion mounted on the second hub, wherein electric current is generated with the rotation of the hubs.

8. The tailpipe decoration of claim 7, further comprising: electrical illumination elements mounted on the second hub and powered by the electric current generated with the rotation of the hub.

9. The tailpipe decoration of claim 6, further comprising: an electric generator comprising a coil portion and a magnet portion, the magnet portion mounted on the second hub and the coil portion mounted on the first hub, wherein electric current is generated with the rotation of the hubs.

10. The tailpipe decoration of claim 7, further comprising: electrical illumination elements mounted on the first hub and powered by the electric current generated with the rotation of the hubs.

11. A tailpipe decoration comprising:
a. a hollow tubular housing;
b. an axle mounted on the housing;
c. a set of turbine blades comprising a hub having a number of radially mounted blades, wherein the set of turbine blades are mounted on the axle;
d. housing connectors mounted on the housing connecting the housing to a tailpipe when the housing connectors are engaged.

12. The tailpipe decoration of claim 11, further comprising: an electric generator comprising a coil portion and a magnet portion, the magnet portion mounted on either the hub and the coil portion mounted on the housing, wherein electric current is generated with the rotation of the hub.

13. The tailpipe decoration of claim 12, further comprising: electrical illumination elements mounted on the housing and powered by the electric current generated with the rotation of the hub.

14. The tailpipe decoration of claim 13, wherein the electrical illumination elements are mounted on the housing behind the set of turbine blades.

15. The tailpipe decoration of claim 13, wherein the electrical illumination elements are tri colored LEDs.
